(19) United States
(12) Patent Application Publication
(10) Pub. No.: US 2021/0146467 A1
(43) Pub. Date: May 20, 2021

(54) WELDING SHIELD

(71) Applicants: Carl Pettersson, Fruitvale (CA); Stig Pettersson, Fruitvale (CA)

(72) Inventors: Carl Pettersson, Fruitvale (CA); Stig Pettersson, Fruitvale (CA)

(21) Appl. No.: 16/687,732

(22) Filed: Nov. 19, 2019

(51) Int. Cl. B23K 9/29; B23K 9/16; B23K 9/167; B23K 10/00

(52) U.S. Cl. CPC B23K 9/296; B23K 10/00; B23K 9/167; B23K 9/164

(57) ABSTRACT

A welding shield that is configured to provide improved gas distribution adjacent a weld seam during the welding process so as to improve the weld quality. The welding shield includes a central member wherein the central member includes contiguously formed sidewalls and a top wall operable to create an interior volume. Mounted within the interior volume is a gas distribution module that is operably coupled to a gas source. A clip member is mounted to the central member and is configured to provide retention of the gas distribution module. A torch retention member is movably mounted to the top wall of the central member. The torch retention member is configured to receive and secure a welding torch and further provide rotational and pivotal movement thereof. A plasma cutter holding member is further included and is operable to releasably retain a plasma cutter.

### FIELD OF THE INVENTION

The present invention relates generally to welding implements, more specifically but not by way of limitation, a welding shield that is configured to provide improved gas coverage during the welding process so as to increase the quality of welds on metals such as but not limited to exotic metals.

### BACKGROUND

Welding is a common technique in many industries and involves the joining of like metals utilizing welding techniques such as but not limited to TIG and/or MIG welding. While welding ferrous metals is fairly routine and can be executed by most welders, the welding of exotic metals such as but not limited to titanium requires a bit more skill and control of other parameters. In order to execute a good weld on exotic metals one of the key parameters to control is gas distribution. As is known in the art, argon gas is commonly utilized in welding. Argon gas or gas blends including argon are utilized in welding to create an inert gas shield during the welding process so as to ensure a good metal transfer during the weld as well as promote an improved weld line. The argon gas or argon gas blend is utilized to protect the molten pool of metal against elements such as but not limited to oxygen and nitrogen until the molten pool hardens.

One problem with welding exotic metals is ensuring the flow and distribution of gas during the welding process. A good weld bead is more difficult to obtain for metals such as but not limited to metals having high nickel alloys. While there are commercially available tools such as but not limited to wielding shields, these shields are deficient when it comes to accommodating various pipe diameters and flat materials. Furthermore, in the arena of pipe welding, current welding shields are not configured to further provide assistance in cutting of the pipe with tools such as but not limited to plasma cutters.

Accordingly, there is a need for a welding shield that is configured to mateably surround an area being welded on pipes having varying diameters as well as flat material and further provide a technique to operably couple with accessories such as but not limited to plasma cutters.

### SUMMARY OF THE INVENTION

It is the object of the present invention to provide a welding shield that is configured to provide improved gas distribution during the welding process of metals such as but not limited to exotic metals wherein the present invention includes a central member.

Another object of the present invention is to provide a welding shield operable to assist in the improved welding of exotic metals wherein the central member includes an interior volume that is substantially hollow and has an opening on the bottom thereof.

A further object of the present invention is to provide a welding shield that is configured to provide improved gas distribution during the welding process of metals such as but not limited to exotic metals that further includes a plurality of wing members wherein the wing members releasably secure to opposing sides of the central member.

Still another object of the present invention is to provide a welding shield operable to assist in the improved welding of exotic metals wherein the central member further includes a torch retention member releasably secured to the top thereof.

An additional object of the present invention is to provide a welding shield that is configured to provide improved gas distribution during the welding process of metals such as but not limited to exotic metals that further includes a gas distribution module disposed in the interior volume of the central member.

Yet a further object of the present invention is to provide a welding shield operable to assist in the improved welding of exotic metals that further includes a plasma cutter holder that is configured to be releasably secured to the central member.

Another object of the present invention is to provide a welding shield that is configured to provide improved gas distribution during the welding process of metals such as but not limited to exotic metals wherein the central member includes a removable rear wall and alternate embodiments thereof.

An alternative object of the present invention is to provide a welding shield operable to assist in the improved welding of exotic metals wherein the wing members are provided in alternate radiuses so as to mateably couple to pipe of alternate diameters.

Yet a further object of the present invention is to provide a welding shield that is configured to provide improved gas distribution during the welding process of metals such as but not limited to exotic metals wherein the wing members are further provided in a flat configuration in order to assist during the welding of two planar sections of metal.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of exemplary embodiments of the wing members of the present invention; and

FIG. 2 is a is a perspective view of an embodiment of the rear wall of the central member of the present invention; and

FIG. 3 is a side perspective view of the present invention with a tig torch; and

FIG. 4 is a side perspective view of the present invention with the plasma cutter holder; and

FIG. 5 is a bottom view of the gas distribution module; and

FIG. 6 is a bottom view of the central member with the gas distribution module secured therein; and

FIG. 7 is a top view of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated a welding shield 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

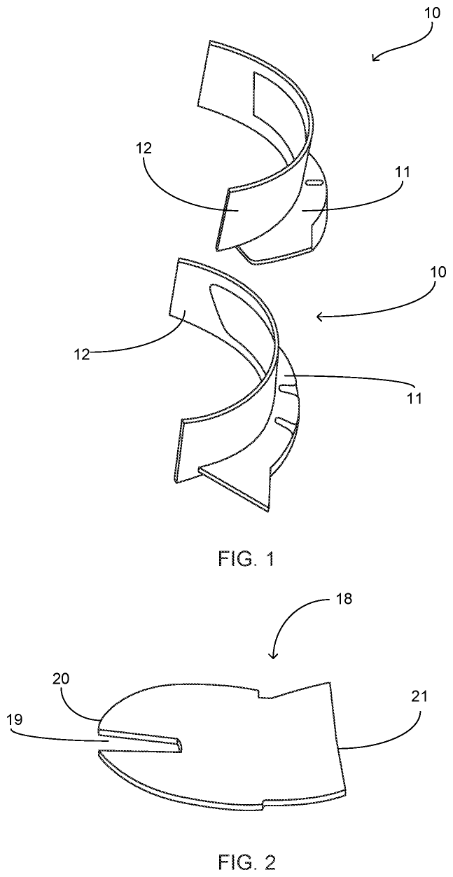

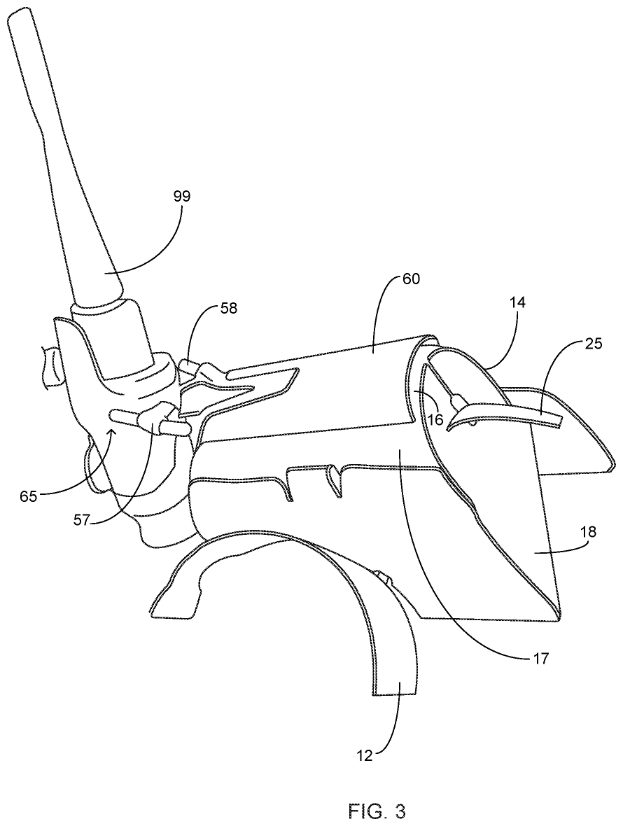

Referring in particular to FIG. 1, the welding shield 100 further includes a plurality of wing members 10. The wing members 10 are releasably secured to opposing sides of the central member 15. The wing members 10 are manufactured from a suitable durable material such as but not limited to metal. The wing members 10 include a first portion 11 and a second portion 12 that are contiguously formed utilizing suitable techniques. The first portion 11 and second portion 12 are perpendicular in orientation. The first portion 11 is configured to be releasably secured to the sides 13, 14 of the central member 15. It is contemplated within the scope of the present invention that the first portion 11 could be configured in alternate manners in order to facilitate the releasable securing of the wing member 10 to the central member 15.

The second portion 12 of the wing member 10 extends outward from the first portion 11 and the sides 13,14 of the central member 15. The second portion 12 of the wing member 10 is planar in manner and is formed having a radius that is equivalent to that of the material being welded. It is contemplated within the scope of the present invention that the radius of the second portion 12 could range from being flat, so as to be utilized during welding sheet metal to having a radius that accommodates various pipe diameters such as but not limited to two, four and eight inch pipe. The second portion 12 of the wing members 10 function to superposedly engage the materials being welded on opposing sides of a weld seam so as to maintain the welding shield 100 in a stable position for the welder. It is contemplated within the scope of the present invention that the wing members 10 could be manufactured having alternate sizes of second portions 12.

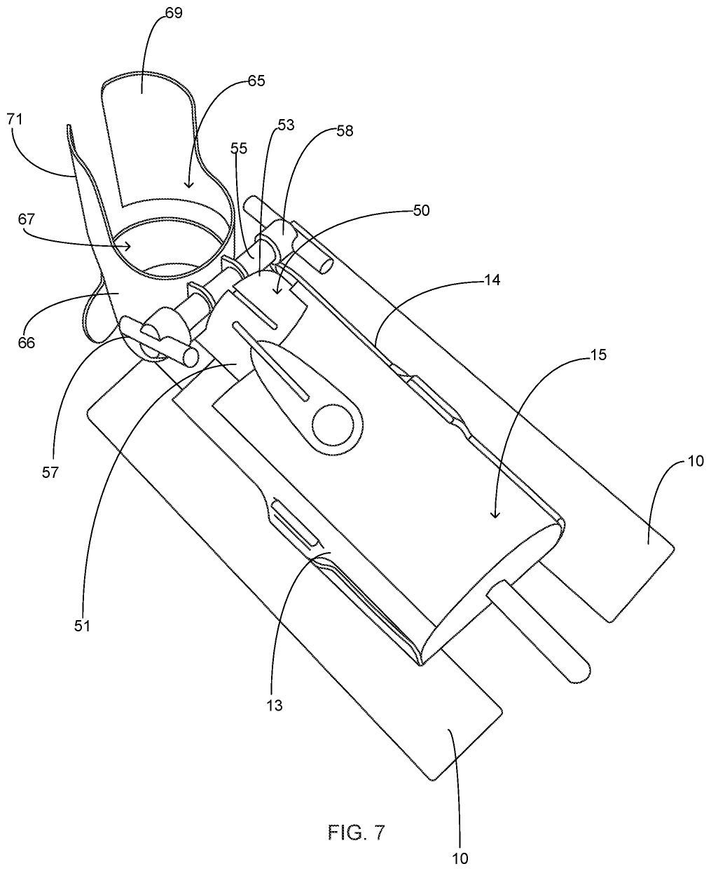

The central member 15 is manufactured from a durable rigid material such as but not limited to metal. The central member 15 includes sides 13,14 and top 16 integrally formed wherein the central member 10 along the top perimeter thereof is rounded in shape. The sides 13, 14 and top 16 are formed to create an interior volume 17, illustrated herein in FIG. 6. The central member 15 further includes a rear wall 18 that is releasably secured to the central member 15. Rear wall 18 is planar in manner and includes a slot 19 extending downward from the upper edge 20 of the rear wall 18. The slot 19 extends approximately half way towards lower edge 21. The slot is configured to accommodate a portion of the gas line intake 25 therethrough. The gas line intake 25 is configured to be sealably coupled to a gas supply hose, such as but not limited to an argon supply hose. The welding shield 100 is provided with alternate embodiments of the rear wall 18 in order to facilitate the sealable superposing of the welding shield 100 on various sizes of pipes and flat material that is being welded.

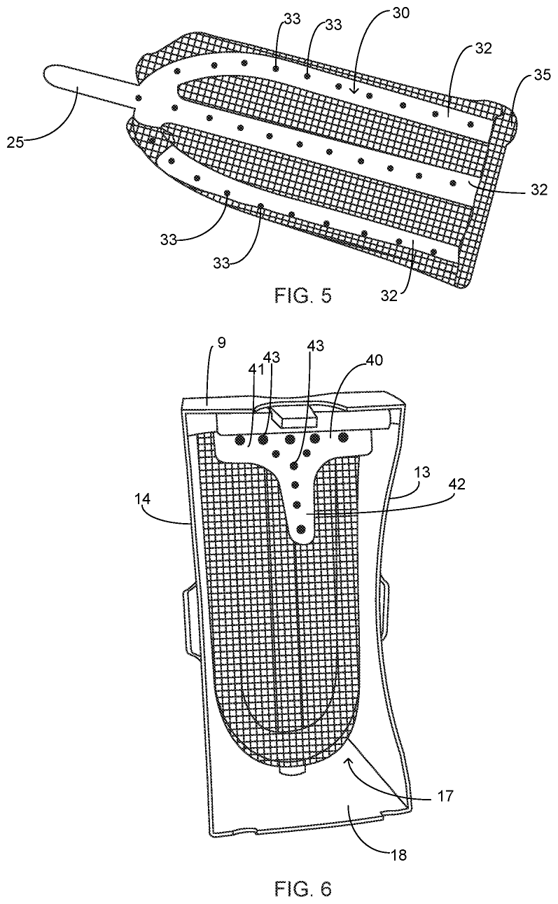

Referring in particular to FIGS. 5 and 6, the gas distribution module 30 of the welding shield 100 is illustrated therein. The gas distribution module 30 is contiguous with the gas line intake 25. The gas distribution module 30 includes a plurality of tube members 32 that are separated in order to facilitate a normalized distribution of gas within the interior volume 15 of the central member 15. The tube members 32 are hollow and have a plurality of apertures 33 formed therein. The tube member 32 along with the apertures 33 are designed to introduce gas into the interior volume 17 of the central member 15 in a manner that ensures substantial filling of the interior volume 17 with a gas such as but not limited to argon in order to facilitate an improved weld seam. While three tube members 32 are illustrated herein, it is contemplated within the scope of the present invention that the gas distribution module 30 could be comprised of more or less than three tube members 32. Furthermore it should be understood within the scope of the present invention that the gas distribution module 30 could have alternate quantities of apertures 33. The gas distribution module 30 further has screen 35 operably secured thereto. The screen 35 functions to assist in the dispersion of gas being introduced into the interior volume 17 of the central member 15 and retain steel wool (not particularly illustrated herein) within the interior volume 17. The apertures 33 are positioned to be facing the top 16 of the central member 15 wherein steel wool is placed intermediate the inner surface of the top 16 and the gas distribution module 30. The arrangement of the tube members 16 in conjunction with the screen 35 and steel wool ensure a consistent distribution of gas within the interior volume 17 of the central member 15.

The gas distribution module 30 is releasably secured within the interior volume 17 of the central member 15 utilizing clip 40. Clip 40 is hingedly secured to the front wall 9 of the central member 15 and is configured to be moved intermediate a first position and a second position. The clip 40 is illustrated in FIG. 6 herein in its second position wherein the clip 40 has been moved so as to be adjacent the gas distribution module 30 disposed within the interior volume 17. The clip 40 includes a first section 41 and second section 42 wherein the second section 42 extends inward towards the rear wall 18. The first section 41 and second section 42 are contiguously formed wherein the second section 42 is formed in a finger-like shaped projection so as to ensure position retention of the gas distribution module 30. It is contemplated within the scope of the present invention that the clip 40 could be formed in alternate shapes and still achieve the desired functionality described herein. The clip 40 further includes a plurality of holes 43 journaled therethrough. The holes 43 are formed to ensure reduced disruption of the gas distribution within the interior volume 17 of the central member 15. As is discussed herein, a consistent gas distribution within the interior volume 17 of the central member 15 ensures a higher quality weld seam.

The welding shield 100 further includes a torch retention member 50. The torch retention member 50 is movably coupled to the central member 15 and is configured to releasably secure a welding torch 99 therein. The torch retention member 50 includes a base support member 51 that is slidably engaged intermediate the top 16 and retention plate 60. The base support member 51 is movably configured to provide an inward/outward movement of the torch retention member 50. It is contemplated within the scope of the present invention that the base support member 51 could be provided in various lengths in order to provide alternate positioning of the welding torch 99 with respect to the central member 15. Secured to the end 53 of the base support member 51 is adjustment assembly 55. The adjustment assembly 55 includes engagement knobs 57,58 and functions to provide pivotal and rotational movement of the torch holding member 65. The torch holding member 65 is configured to have releasably secured therein welding torch 99. The torch holding member 65 includes wall member 66 that is that is annular in shape forming opening 67 being of suitable size to accommodate the welding torch 99. A keeper 68 is contiguously formed with the wall member 66 and is operable to be biased against the welding torch 99 ensuing the welding torch 99 being mounted within the torch holding member 65. The wall member 66 includes upper portions 69,71 that extend upward therefrom. Upper portion 69,71 are operable to enhance the surface engagement of the welding torch 99 and provide an improved stabile connection therewith. The keeper 68 is arcuate in shape having a radius generally equivalent to the wall member 66. It is contemplated within the scope of the present invention that the torch holding member 65 could be constructed in alternate manners and achieve the desired functionality described herein.

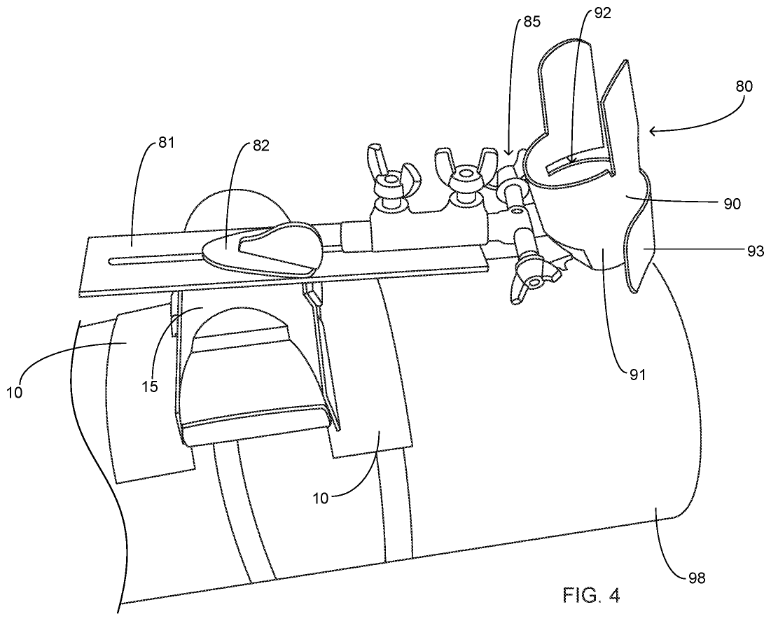

Referring now in particular to FIG. 4 herein, the welding shield 100 further includes a plasma cutter holding member 80. As is known in the art, plasma cutters can be utilized to cut various metals and utilizes a plasma jet to execute the task. The welding shield 100, specifically the central member 15 thereof, is adapted to have releasably secured thereto a plasma cutter holding member 80. The plasma cutter holding member 80 is similarly constructed to the torch retention member 50 and facilitates retention and positional adjustment of a plasma cutter (not illustrated herein) in order to cut a desired metal object such as an exemplary pipe 98. The plasma cutter holding member 80 includes base support member 81 that is slidably secured to the top 16 of the central member 15 utilizing fastener 82. The base support member 81 provides the ability for positional adjustment of a plasma cutter (not illustrated herein) relative to the central member 15. The plasma cutter holding member 80 further includes an adjustment assembly 85 and plasma retention ring 90. The adjustment assembly 85 is movably secured to the base support member 81 so as to provide pivotal and rotational movement of the plasma retention ring 90. The plasma retention ring 90 includes wall 91 that is annular in shape forming opening 92 wherein a plasma torch will be biasly mounted within the opening 92 utilizing clip wall member 93. As is shown in FIG. 4, the wing members 10 have the same radius as the exemplary pipe 98 and as such the welding shield 100 provides a stabile platform for a user to utilize the plasma cutter holding member 80 in order to execute a desired cut. While a particular embodiment of the plasma cutter holding member 80 has been disclosed herein, it is contemplated within the scope of the present invention that the welding shield 100 could be provided with a plasma cutter holding member 80 formed in alternate manners.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A welding shield that is configured to provide an improved distribution of gas adjacent a weld seam during the welding process comprising:
a central member, said central member having opposing side walls contiguously formed with a top wall forming an interior volume, said central member having a first end and a second end;
a pair of wing members, said pair of wing members being mounted to said opposing side walls, said pair of wing members having a first portion and a second portion, said first portion of said pair of wing members being releasably secured to said opposing side walls, said first portion and said second portion of said pair of wing members being perpendicular in orientation, said second portion of said pair of wing members extending outward from said central member;
a gas distribution module, said gas distribution module being disposed within said interior volume of said central member, said gas distribution module configured to dispense gas into said interior volume of said central member, said gas distribution module being operably coupled to a gas line intake; and
a torch retention member, said torch retention member being moveably coupled to said top wall of said central member, said torch retention member configured to releasably secure a welding torch in a portion thereof, said torch retention member configured to be extendable from said central member, said torch retention member operable to provide rotational and pivotal adjustments of a welding torch engaged therewith.

2. The welding shield as recited in claim 1, and further including a clip, said clip operably coupled to said central member, said clip having a first position and a second position, said clip configured to retain said gas distribution module within said interior volume of said central member in said second position.

3. The welding shield as recited in claim 2, wherein said pair of wing members are formed in one of the two following shapes: flat or arcuate.

4. The welding shield as recited in claim 3, wherein said gas distribution module further includes at least one tube member, said at least one tube member having a plurality of apertures configured to have gas expelled therefrom.

5. The welding shield as recited in claim 4, and further including a plasma cutter holding member, said plasma cutting holding member being movably secured to said top wall of said central member, said plasma cutter holding member configured to secure a plasma cutter therein.

6. The welding shield as recited in claim 5, wherein said torch retention member further includes an adjustment assembly, said adjustment assembly operable to provide pivotal and rotational movement of the welding torch secured within the torch retention member.

7. The welding shield as recited in claim 6, and further including a screen, said screen being secured adjacent to said gas distribution module.

8. A welding shield that is configured to provide an improved distribution of gas adjacent a weld seam during the welding process so as to provide a superior weld quality comprising:
a central member, said central member having opposing side walls contiguously formed with a top wall forming an interior volume, said top wall being arcuate in form, said central member having a rear wall, said rear wall having a slot formed therein, said central member having a first end and a second end;
a first wing member and a second wing member, said first wing member and second wing member being mounted to opposing side walls, said first wing member and second wing member having a first portion and a second portion, said first portion of said first wing member and second wing member being releasably secured to said opposing side walls, said first portion and said second portion of said first wing member and second wing member being perpendicular in orientation, said second portion of said first wing member and second wing member extending outward from said central member, said first portion of said first wing member and second wing member being configured to be releasably secured to said sidewalls;
a gas distribution module, said gas distribution module being disposed within said interior volume of said central member, said gas distribution module configured to dispense gas into said interior volume of said central member, said gas distribution module further including a plurality of tube members, said gas distribution module being operably coupled to a gas line intake; and
a torch retention member, said torch retention member operable to receive an secure a welding torch therein, said torch retention member being moveably coupled to said top wall of said central member, said torch retention member further including a base support plate, said base support plate having a first end and a second end, said base support plate slidably mounted to said top wall of said central member, said base support plate of said torch retention member configured to be extendable from said central member, said torch retention member further including an adjustment assembly, said adjustment assembly secured to said first end of said base support plate, said adjustment assembly configured to provide rotational and pivotal movement of the welding torch.

9. The welding shield as recited in claim 8, and further including a gas line intake, said gas line intake being contiguously formed with said gas distribution module, wherein a portion of said gas line intake being journaled through said slot of said rear wall.

10. The welding shield as recited in claim 9, and further including a clip, said clip having a first section and a second section, said clip being movable intermediate a first position and a second position, said clip further having a plurality of holes formed therein.

11. The welding shield as recited in claim 10, wherein said torch retention member includes a wall member, wherein said wall member of torch retention member is annular in shape forming an opening, said opening configured to receive the welding torch.

12. The welding shield as recited in claim 11, and further including a plasma cutter holding member, said plasma cutting holding member being movably secured to said top wall of said central member, said plasma cutter holding member configured to secure a plasma cutter therein.

13. The welding shield as recited in claim 12, wherein said first wing member and second wing member are formed in one of the two following shapes: flat or arcuate.

14. The welding shield as recited in claim 13, wherein said plurality of tube members further include a plurality of apertures, said plurality of apertures being oriented towards said interior volume of said central member.

15. A welding shield that is configured to provide distribution of gas adjacent a weld seam during a welding process of two metal wherein the distribution of gas provides a superior weld quality wherein the welding shield comprises:
a central member, said central member having opposing side walls contiguously formed with a top wall forming an interior volume, said top wall being arcuate in form, said central member having a rear wall, said rear wall being removably mounted to said central member, said rear wall having a slot formed therein, said central member having a first end and a second end;
a first wing member and a second wing member, said first wing member and second wing member being mounted to opposing side walls, said first wing member and second wing member having a first portion and a second portion, said first portion of said first wing member and second wing member being releasably secured to said opposing side walls, said first portion and said second portion of said first wing member and second wing member being perpendicular in orientation, said second portion of said first wing member and second wing member extending outward from said central member, said first portion of said first wing member and second wing member being configured to be releasably secured to said sidewalls;
a gas distribution module, said gas distribution module being disposed within said interior volume of said central member, said gas distribution module configured to dispense gas into said interior volume of said central member, said gas distribution module further including a gas line intake, said gas line intake being contiguously formed with said gas distribution module, wherein a portion of said gas line intake being journaled through said slot of said rear wall, said gas distribution module further including a plurality of tube members, said gas distribution module being operably coupled to a gas line intake; and
a torch retention member, said torch retention member operable to receive an secure a welding torch therein, said torch retention member being moveably coupled to said top wall of said central member, said torch retention member further including a base support plate, said base support plate having a first end and a second end, said base support plate slidably mounted to said top wall of said central member, said base support plate of said torch retention member configured to be extendable from said central member, said torch retention member further including an adjustment assembly, said adjustment assembly secured to said first end of said base support plate, said adjustment assembly configured to provide rotational and pivotal movement of the welding torch.

16. The welding shield as recited in claim 15, wherein said plurality of tube members further include a plurality of apertures, said plurality of apertures being oriented towards said interior volume of said central member.

17. The welding shield as recited in claim 16, and further including a plasma cutter holding member, said plasma cutting holding member being movably secured to said top wall of said central member, said plasma cutter holding member configured to secure a plasma cutter therein, said plasma cutter holding member configured to provide rotational and pivotal movement of a plasma cutter.

18. The welding shield as recited in claim 17, wherein said torch retention member includes a wall member, wherein said wall member of torch retention member is annular in shape forming an opening, said opening configured to receive the welding torch.

19. The welding shield as recited in claim 18, wherein said plasma cutter holding member further includes a clip wall member, said clip wall member configured to at least partically circumferentially surround a plasma cutter in order to secure the plasma cutter within said plasma cutter holding member.

20. The welding shield as recited in claim 19, wherein said first wing member and second wing member are formed in one of the two following shapes: flat or arcuate.
